(19) United States
(12) Patent Application Publication
(10) Pub. No.: US 2014/0079864 A1
(43) Pub. Date: Mar. 20, 2014

(54) MEAT SUBSTITUTE PRODUCT, MEAT AND MEAT SUBSTITUTE COMPOSITE AND METHODS OF PREPARATION

(71) Applicant: Mayzing Food Inc., Capitola, CA (US)

(72) Inventor: S. SWAMINATHAN, LA SELVA BEACH, CA (US)

(73) Assignee: Mayzing Food Inc., Capitola, CA (US)

(21) Appl. No.: 13/965,064

(22) Filed: Aug. 12, 2013

Related U.S. Application Data
(60) Provisional application No. 61/681,836, filed on Aug. 10, 2012.

(51) Int. Cl. A21D 13/00; A23L 1/317

(52) U.S. Cl. CPC A21D 13/0067; A23L 1/3177
USPC 426/549; 426/645

(57) ABSTRACT

A food product and method for forming a food product including vital wheat gluten flour, seasoning and water, involving mixing the vital wheat gluten flour with the seasoning and water to form a dough, cooking the dough and grinding the cooked product to a desired size, which may then be pressed to form a any desired shape, such as a patty, sphere or other form, or otherwise used as is.

### CROSS-REFERENCE TO RELATED APPLICATIONS

This application claims the benefit of U.S. Provisional Patent Application No. 61/681,836, which was filed Aug. 10, 2012, the disclosure of which is incorporated herein by reference.

### BACKGROUND OF THE INVENTION

This invention relates to edible food compositions, and relates generally to a proteinaceous material suitable as a meat substitute and to its preparation, and more particularly to a non-meat-derived proteinaceous material which is both economically and characteristically desirable as a substitute for ground meat and as a blend with meat to provide fortified protein, color stabilization and enhanced shelf life in various food preparations.

### SUMMARY OF THE INVENTION

Some embodiments of the invention are directed to a prepared food product or food item, comprising vital wheat gluten flour; one or more seasoning agents; and water at a temperature ranging from 35° F. to 100° F., wherein the flour, one or more seasoning agents and water are mixed to form a dough, the dough being subjected to the following steps: cooked at a temperature greater than 60° F.; cooled to a temperature less than 60° F.; and then grinded or processed through a pressurized grind plate or otherwise processed to form a desired size and/or shape.

In some embodiments, the moisture content of the product is less than 95%.

The dough may also be stored prior to cooking at a temperature ranging from −20° F. to 40° F. The dough is heated from storage to a temperature range from greater than 7° F. to 40° F.

The food product may also include a slurry including salt and an edible oil, wherein the slurry is mixed with the ground product.

In some embodiments, the ground dough is pressed into a desired shape, such as a patty shape or spherical (for appearing as meatballs, meatloaf, nuggets, etc.) and the dough may also be cut before cooking to any shape and then used as is or ground into small or large pieces as needed.

Some embodiments of the invention are directed to a method for forming a prepared food product or item, comprising the steps of: mixing vital wheat gluten flour with one or more seasoning agents to form a dry mixture; mixing the dry mixture with water at a temperature ranging from 35° F. to 100° F. to form a dough; cooking the dough at a temperature greater than 60° F.; cooling the resulting cooked product to a temperature less than 60° F.; and grinding the cooked product to a desired size.

The aforementioned method may also include the step of mixing the ground product with a slurry including salt and an edible oil or combining the ground product with ground beef and pressing the combination together to form a patty shape, with or without the slurry.

Some embodiments of the invention are also directed to a method for forming a prepared food product or item, comprising the steps of: mixing vital wheat gluten flour with one or more seasoning agents to form a dry mixture; mixing the dry mixture with water at a temperature ranging from 35° F. to 100° F. to form a dough; heating the dough in water at a temperature range of 160° F. to 230° F.; cooling the cooked product to a temperature less than 40° F.; and grinding the cooked dough through a grinding plate. The method may also include the step of mixing the ground product with a slurry including salt and an edible oil. The method may also include the step of mixing the mixture of ground product and beef, with or without the slurry, before pressing the resulting mixture into a desired shape, such as a patty or nugget or sphere for example. The aforementioned method may also include the step of lowering the temperature of the dough to a temperature between the range of −20° F. and 40° F.

### DETAILED DESCRIPTION OF THE INVENTION

The invention generally relates to a non-meat or meat substitute product, a blended or composite product containing meat and a meat substitute product, and various methods for the preparation of the meat substitute and composite meat products.

In an exemplary embodiment, the process for producing a meat substitute of the invention includes the step of combining vital wheat gluten flour with seasonings, seasoning agents or flavoring agents, such as FNA2 Seasoning mix which may include vital gluten flour (wheat protein), barley flour, mushrooms, yeast salt, pepper and spices, among other things. The combination of flour and seasonings may be mixed by any conventional means for a period of time as required to ensure a relatively uniform distribution. For example, the combination may be mixed for 1 to 15 minutes using a Hobart 20 gallon mixer with dry mixing arm. Water is then added and mixed through any conventional means. The water may be at any temperature, but is preferably at a temperature from about 35° F. to about 100° F. As an example, the Hobart 20 gallon mixer may be fitted with a dough hook and used to mix the water with the flour and seasonings.

After mixing the dough may be cut into pieces of any size, such as pieces between 2 grams and 16 kg. The pieces can be wrapped in plastic wrap, bagged, boxed or placed in a container to be frozen for later use. The dough can be frozen and held at a temperature ranging from −20° F. through 40° F. When thawing frozen dough for cooking or otherwise, it is preferably thawed until reaching the desired temperature which may range from −20° F. to 60° F.

Alternatively, the dough may be immediately cooked. Prior to cooking the dough can be processed, sized or shaped by using industrial extruders, saws, grinders, choppers, slicers, and dicers on the dough within the temperature range of −20° F. to 60° F. The processed dough can then be cooked by any conventional means, such as by immersing into a cooking vessel. For example, the dough may be immersed into a square stainless steel tank or a steam jacketed kettle (full, ½ or ¾ of the kettle) after grinding, slicing, dicing, or chopping, to define the shape of the dough. In some embodiments it has been found that maintaining the dough at cooler temperatures will help minimize sticking during cooking and facilitating uniform cooking.

In a non-limiting example, the dough may be sliced into 2 kg pieces or sheets having a thickness ranging from about 5 mm to about 100 mm. The sheets can be cooked as they are for a steak-like appearance, sliced into cubes, or ground up into small pieces and cooked to form crumbles. In another non-limiting example, 16 kg pieces can be sliced on a large meat saw to the size appropriate to fit into the chamber of a commercial meat dicer and diced into desired shapes and sizes.

In the process of cooking the dough in water, the water temperature is preferably between 160° F. and 230° F. (or otherwise the boiling point at 1 atmosphere of pressure or equivalent). By way of example, it has been found that crumbles can cook in about 20 minutes, 5 mm×5 mm×5 mm cubes cook in about 45 minutes, 20 mm×20 mm×20 mm cubes cook in about 3.5 hours, and 100 mm×100 mm×100 mm cook in about 10 hours.

Irrespective of the cooking method or particulars, moisture content of cooked dough or product is preferably between 1% and 95%, depending upon intended application for the product.

Some embodiments of the invention are directed to cooking methods for the dough involving cooking vessels as described herein. The dough may be sliced or cut up prior to adding to the cooking vessel. The vessels for cooking the dough should include a rectangular stainless steel tank (of various dimensions, such as 3 ft×4 ft×3 ft up to 15 ft×20 ft×6 ft) with stainless tubing at the bottom that provides steam generated by a steam boiler, transmitting the generated steam to the tubing to radiate heat and heat the water to cook the dough. The dough may be inserted into the tank via baskets, either manually inserted or via an overhead rail system which includes a mechanical system to configured to lower and raise the baskets, along a bank of tanks. Once the dough is cooked, the baskets are lifted and transported along the rails to the cooling tanks, where the temperature is reduced to preferably at least 40° F. The cooked product is then drained from the tank and moved to a freezer system.

In another embodiment, a continuous cooking method can be employed wherein the dough is carried through the water during cooking and through the cooling, dewatering, and freezing system using a larger tank, as described above, but including a continuous dwell paddle system, timed to continually feed dough into the tank and use the paddles to move the dough, while the dough cooks through the cooking tank, until it cooks to the programmed time; then, using the paddles to raise the cooked product out of the tank onto a conveyor that moves the cooked product to a similar tank, which is filled with chilled water or ice to reduce the temperature. The same dwell paddle system to remove the product, once chilled to the programmed temperature, and pass it on another conveyor, which transports the chilled product into the freezer to be frozen, either in individually quick frozen pieces (such as individually quick frozen) or as a weighted block of approximately 10 lbs.

After cooking the product is removed from the cooking vessel and cooled though any conventional means, such as immersing the product into a bath of ice, water and/or chilled water or a chilled water solution with seasonings or without seasonings (which may be at 0° F. to about 40° F.), which may be a cost-effective alternative to using freezers to bring down the temp of the cooked product.

Once chilled to below 40° F., the product may be dewaterized, packaged and/or frozen for storage.

An exemplary method and use of the product is to make patties, such as hamburger patties. The exemplary method may or may not involve a slurry preparation. The slurry may include dry ingredients (such as salt and a binder) are weighed and mixed together, wet ingredients (such as oil and natural flavorings) are weighed and mixed together, which are then blended together for 2 minutes or until the mixture is a homogenous slurry. Pieces of the product described above are tempered to a range of 10° F. to 40° F., mixed for 2 minutes, and then ground through a ⅜ inch grinding plate. The slurry is added to the grind, and mixed for an additional 3 minutes or until homogenized. The mix may be ground again through the ⅜ inch plate and ready for forming into patties.

Additionally variations in the grind plate sizes (such as 1/32 inch, 1/16 inch, ⅛ inch, ¼ inch, ⅜ inch, ½ inch, ⅝ inch, ¾ inch, ⅞ inch, and 1 inch grind plates, respectively) creates the opportunity to develop different textures in the final product.

The patty may be formed or shaped by feeding into a patty former which presses the ground combination into patties, which can be frozen, bagged, boxed, and removed to cold storage.

Variations in the pressures exerted (From 10-300 psi) during the patty forming process creates opportunity to further augment the texture of products and when utilized in conjunction with variations in the grind plate sizing, it provides the scope to create products with a multitude of textures unique to the product. Similar to the different textures available when ordering meat cooked “rare through well done”, the product may also be made to have textural variations by varying the grind size and varying the pressing steps.

When the product is heated, either rapidly as in a convection oven (125°-450° F.) and deep fryer (325°-450° F.), or slowly in a smoker (from about 145 to 350° F.) or other food dehydrator (115°-200° F.), as moisture evaporates from the product, the texture can vary greatly. Starting from the soft like a “rare” steak (90% moisture), all the way to crunchy like a potato chip (10-60% moisture). Even up to removing 99% of all the moisture, can significantly extend shelf life from days to years depending on how the moisture is removed, how the product is processed, and finally storage conditions. The durability of the product to handle all these process and still be able to rehydrate so effectively creates a unique product that has not been seen before. The textural varieties available to the product demonstrates its uniqueness and amazing adaptability to a variety of processes that is not found in any other source of protein.

The product may also be dehydrated by direct, indirect, radiant, steam, infrared, etc. to remove moisture at a variety of temperatures from 110° F.-500° F. These moisture reduction processes advantageously enable different forms of the product to be developed, such as jerky, skirt steaks, protein nutrition bars and shelf stable products for retail, foodservice and industrial use, as well as producing a shelf stable product that can be shipped unrefrigerated, competitively and cost-effectively to emerging markets, like India, Africa and China, as a low-cost sustainable protein.

The product may be combined with meat, such as beef. Pressure in the grinding process may be adjusted to produce a product having uniform color (called bloom in the meat industry), when blended with ground beef without adding additional coloring agents.

The grind plate size may be selected to produce uniquely textured products, both as vegan products, like burgers, meatballs, etc; and blended products like burgers, meatballs, sausage patties, meatloafs, etc. The diameter range of grind plates varies from about 1/32″ to 1″. In some embodiments, the pressure on the patty forming equipment can range between 10 and 300 psi, which produces a unique patty or burger that produces the characteristic bite, reminiscent or ground beef.

In some embodiments, the meat substitute product comprises wheat protein, barley flour, nutritional yeast, seasonings and water. The meat substitute may include the aforementioned constituents in the following ranges: wheat protein from about 10 to about 45%; barley flour may range from about 1 to about 15%; nutritional yeast from about 0.1 to about 3%; water may range from about 15 to about 90%; and seasonings may be added as necessary depending on the desired flavor.

In some embodiments, the invention is directed to a fortified meat product comprised of a meat, which may be one or more of pork, turkey, chicken, fish or beef, for example, which is fortified with a non-meat product or substitute as described above.

The invention is also directed to a method for preparing a meat substitute and composite meat products that includes various processing steps. In some embodiments, the processing includes the following steps: prepare dry ingredients, which may include a proprietary blend (FNA), nutritional yeast and seasonings; mix dry ingredients with wheat protein and barley; add water to make a dough; develop the dough; lower the temperature of the dough; apportion the dough; cook the dough; drain and cool the product; blend with added ingredients seasonings and colorings, such as a coloring agent that turns from raw red to cooked brown, natural flavorings, and a carrier of anti-oxidants to extend shelf life of a composite meat and meat substitute blend; and blend with ground beef or other meat.

In some embodiments, the product may be placed in a modified atmosphere packaging to preserve shelf life in shipment having a specific tri-gas mixture (nitrogen, oxygen, carbon dioxide) formula to preserve product during packaging.

A number of changes are possible to the ingredients, methods and equipment described above, while still remaining within the scope and spirit of the invention. The invention is intended to offer greater flexibility in ingredients, flavors and processes to accommodate a very wide range of needs, including needs relating to specific cuisines and individual preferences, and a wide range of available foods. The invention is not to be limited in any way by the specific information provided herein, and the skilled artisan will appreciate that various modifications, substitutions, omissions, and changes may be made without departing from the spirit thereof. Accordingly, the invention embraces alternatives, modifications and variations which fall within the spirit and scope of the invention as set forth in the claims and equivalents thereto.

What is claimed is:

1. A prepared food product, comprising:
a) vital wheat gluten flour;
b) one or more seasoning agents; and
c) water at a temperature ranging from 35° F. to 100° F.,
wherein the flour, one or more seasoning agents and water are mixed to form a dough, the dough being subjected to the following steps to form the food product: cooked at a temperature greater than 60° F.; cooled to a temperature less than 60° F.; and then grinded through a pressurized grind plate to form a desired size.

2. A food product as recited in claim 1, wherein the moisture content is less than 90%.

3. A food product as recited in claim 1, wherein the dough is stored prior to cooking at a temperature ranging from −20 to 40° F.

4. A food product as recited in claim 3, wherein the dough is heated from storage to a temperature range from greater than 20° F. to 230° F.

5. A food product as recited in claim 1, further comprising a slurry including salt and an edible oil, wherein the slurry is mixed with the cooked product.

6. A food product as recited in claim 1, wherein the ground product is pressed into a patty shape.

7. A method for forming a prepared food product, comprising the steps of:
a) Mixing vital wheat gluten flour with one or more seasoning agents to form a dry mixture;
b) Mixing the dry mixture with water at a temperature ranging from 0° F. to 230° F. to form a dough;
c) Cooking the dough at a temperature greater than 60° F.;
d) Cooling the cooked product to a temperature less than 60° F.; and
e) Grinding the cooked product to a desired size.

8. A method according to claim 6, further comprising the step of mixing the ground product with a slurry including salt and an edible oil.

9. A method according to claim 6, further comprising the steps of: combining the ground product with ground beef and pressing the combination together to form any desired shape.

10. A method according to claim 6, further comprising the step of pressing the ground product into a patty shape.

11. A method for forming a food product, comprising the steps of:
a) Mixing vital wheat gluten flour with one or more seasoning agents to form a dry mixture;
b) Mixing the dry mixture with water at a temperature ranging from 35° F. to 100° F. to form a dough;
c) heating the dough in water at a temperature range of 160° F. to 230° F.;
d) Cooling the cooked product to a temperature less than 40° F.; and
e) Grinding the cooked product through a grinding plate.

12. A method for forming a food product according to claim 11, further comprising the step of mixing the ground product with a slurry including salt and an edible oil.

13. A method for forming a food product according to claim 12, further comprising the step of pressing the mixture of ground product and slurry into any desired shape.

14. A method for forming a food product according to claim 11, further comprising the step of mixing the mixture of ground product with ground beef.

15. A method for forming a food product according to claim 14, further comprising the step of pressing the mixture with ground beef into a patty shape.

16. A method for forming a food product according to claim 11, further comprising the step of lowering the temperature of the dough to a temperature between the range of −20° F. and 40° F.

17. A method for forming a food product according to claim 11, further comprising the steps of mixing the mixture of ground dough with ground beef and pressing the mixture into a spherical shape.
